(19) United States
(12) Patent Application Publication
(10) Pub. No.: US 2025/0225891 A1
(43) Pub. Date: Jul. 10, 2025

(54) USER-CHOICE-MEDIATED EXERCISES

(71) Applicant: Rodney Adrain Weems, Bethlehem, PA (US)

(72) Inventor: Rodney Adrain Weems, Bethlehem, PA (US)

(21) Appl. No.: 19/013,131

(22) Filed: Jan. 8, 2025

Related U.S. Application Data
(60) Provisional application No. 63/619,093, filed on Jan. 9, 2024.

(51) Int. Cl. G09B 19/06

(52) U.S. Cl. CPC G09B 19/06

(57) ABSTRACT

An app for teaching a foreign language to a user proficient in a native language (a) tracks the user's current proficiency level in the foreign language, where the current proficiency level increases with the user's proficiency in the foreign language, (b) receives from the user a current word or phrase in the native language, and (c) generates a number of current exercises for the user to perform based on (i) a translation of the current word or phrase in the foreign language and (ii) the user's current proficiency level in the foreign language. Higher proficiency levels in the foreign language are associated with syntaxes of greater complexity. The app maintains, for the user, a user database of words and/or phrases contained in previous exercises and generates one or more of the current exercises based on at least some of the words and/or phrases in the user database.

### CROSS-REFERENCE TO RELATED APPLICATIONS

This application claims the benefit of the filing date of U.S. provisional application No. 63/619,093, filed on Jan. 9, 2024, the teachings of which are incorporated herein by reference in their entirety.

### BACKGROUND

### Field of the Disclosure

The present disclosure relates generally to automated systems and methods for student second-language instruction.

### Description of the Related Art

This section introduces aspects that may help facilitate a better understanding of the disclosure. Accordingly, the statements of this section are to be read in this light and are not to be understood as admissions about what is prior art or what is not prior art.

A number of automated, highly popular, second-language instructional systems abound. Duolingo is typical of the approach taken by these systems. Systems in this category follow what is essentially a linear learning path or map. At each step along the path, a new set of vocabulary and/or new linguistic skills is/are introduced for students to begin to master.

A student's facility or prior experience with a language may allow them to move quickly through this sequence. They may skip steps along the path if they have related prior experience or can intuit larger linguistic patterns without having to be explicitly taught. They may also be able to skip steps if they have a facility for vocabulary acquisition such that large amounts of review are unnecessary. Regardless, the path in such apps remains essentially linear.

Along this linear path, the user is frequently offered a choice of “side” exercises, but these exercises are predetermined. New offerings become available based on where a person is on the language-acquisition pathway or, based on their performance level, on various elements along the path prior to that point.

One example of such a side offering is a canned iconic or epic story. Once a user reaches a certain point on the learning path, iconic story number-one becomes a side offering. Whether a user avails himself of the offering is purely up to him.

As users progress, additional stories are added to the menu of choices. For example, one iconic story about family, one about breakfast, one about shopping, and so on. These stories vary little; they are the same or similar every time. This is purposeful because the comprehensible-input theory of second-language acquisition hypothesizes that these iconic, unchanging narratives build confidence by allowing repeated reference to familiar, predictable stories.

A second example of such a side offering is presenting possible exercises composed of the highest probability errors a student has made to that point along the path.

There are numerous problems with this traditional, linear approach. But the most-important problem is that familiarity and predictability have their limits. Although the traditional approach is perfect for easy implementation in a computerized, automated-application environment, it has shortcomings in terms of generating the intense interest that can produce the highest learning gains, especially those required to reach the fluency levels necessary to obtain a visa or work permit.

Fahrurrozi “shows there is a strong connection between interest and reading comprehension, and that self-selected reading resulted in substantial vocabulary gains and higher TOEIC (Test of English for International Communication) scores.” See Fahrurrozi, “Relationship Between Students” Reading Interest and Vocabulary Mastery with Reading Comprehension Ability (2017) Atlantis Press, 118 (59), 357-363, the teachings of which are incorporated herein by reference. Krashen, who many consider the father of the theory that underpins most modern, second-language teaching methods, has conducted research that shows the same for self-selected spoken language and vocabulary. See Beniko Mason and Stephen Krashen, “Self-Selected Reading and TOEIC Performance: Evidence from Case Histories” (March 2017), the teachings of which are incorporated herein by reference.

Other research shows that, when information is learned in highly interrelated chunks, the brain stores those parts more efficiently, as if they are a single whole. So, learning the words “dog,” “bark,” “pet,” and “run” together is more advantageous to word acquisition, retention, and learning rate than learning the word “dog” in isolation.

### SUMMARY

Various embodiments disclosed herein are directed at creating an interactive, computerized learning environment that overcomes the shortcoming of existing tools and methods currently in or proposed for use to increase the rate of student second-language acquisition. All methods for meeting this need proposed herein are based on the present disclosure of user choice-mediated exercises.

The present disclosure relates to a method of increasing the rate of second-language acquisition by providing a system that can target and train students in second-language elements that intersect individually important daily routines, areas of interest, expertise, or concern.

Because of these efficiency-enhancing effects, examples abound of the person who needs to gain high proficiency in a narrow section of a language and who is able to do so in a short span of time because the need and interest are high-the math student who barely speaks the language but soon has little trouble with written or spoken math problems in his new language; the athlete who converses fluently with same-sport coaches, referees, and athletes, but who has considerably more trouble with her new language outside that narrow context; the piano teacher who quickly masters a small segment of a second language so she can converse with a new foreign student, and so on.

These examples highlight ways an automated learning system that harnesses the power of high-interest user choices would enhance learning of the target language.

But app producers are concerned with more than just ensuring students learn the target language. They are also concerned with profit and app-usage rates.

The field of habit formation shows that a new habit is more easily formed if it is attached to an existing habit. See Maddy Osman, “Use Habit Stacking To Change Your Behavior and Create New Routines” (May 2, 2023). Attaching the study of language to a recurrent daily need will increase both the regularity and frequency of app usage.

Each time the user enters a recurrent real-life situation of linguistic concern, using the app to aid language acquisition specific to that recurrent setting will be a natural secondary occurrence. The secondary habit of using the app in that setting will, thus, attach itself to the primary habit of regularly needing to navigate that real-life situation.

This will aid language acquisition, of course. But as a matter of pure economics and profit, harnessing this pattern of habit formation by incorporating this disclosure into old and new language-acquisition applications can increase profits. It does so by providing a method of learning that is powerful enough to drive profits via the desirability of a service that fits naturally into the habit-formation flow of a user's established daily routine.

For all these reasons, a computerized system is needed that can harness the power of practicing high-interest vocabulary and narratives that falls outside of the standard linear progression of a computerized application but within the sphere of immediate user needs and interests. This disclosure describes such a system.

In one such preferred embodiment of a user-choice-mediated system, a user can enter a desired word (aka choice-word) from their native language. The system will assess where along the linear learning path the user is. It will then supply an exercise set composed of words, phrases, sentences, and/or images that a) employs the choice-word in a realistic, real-world context and b) uses linguistic structures and vocabulary that are appropriate for where the user is along his learning path—neither too simple nor too complex for the user's current skill level.

In one embodiment of this disclosure, no new learning-path words beyond the single choice-word a user has entered will be used to construct the user choice-mediated exercises. All other words will be drawn from the learning bank as it exists at that point on the learning path. In the early stages of learning, template lessons in such an embodiment would be simplistic.

In more-advanced stages along the linear learning path, the choice-word could be employed in more creative ways because more vocabulary is available to compose creative phrases and sentences. In one version of this embodiment, the word could be used in sentences that are simple but true-to-life statements. For example, if the user entered the word “dog”, the user could be asked to work with target-language phrases like, “Is this a dog?”, “This dog is large,” “Is this your dog?”, “I like dogs,” “I like large dogs,” and so on.

In preferred embodiments of this disclosure, a user can enter a choice-word from their native language. The system will then assess where along the learning path the user is. Then the system will supply an exercise set composed of words, phrases, sentences, and images that a) employs a translation of the choice-word in the target language in realistic, real-world contexts and b) uses linguistic patterns/templates and vocabulary that are appropriate for where a user is along his linear learning path, and c), as an extension of the last embodiment, also introduces new vocabulary that has a high-probability, real-world association to the user's choice-word.

For instance, reconsider the last example where “dog” was the native-language choice-word. Even though a user might be fairly early in their learning path, new vocabulary associated with the choice-word could be introduced in versions of this preferred embodiment. Instead of working with target-language phrases like “The dog” or “I like dogs,” the application could now employ phrases like “The furry dog,” “The barking dog,” “I like to walk dogs,” or “The dog is running.” In this case, “furry,” “barking,” and “running” are words with a high-frequency association to dogs. But low-frequency words, like “furry” and “barking”, will likely not have been previously encountered along the learning path.

In some versions of this preferred embodiment, new target-language words that have a high-probability association with the choice-word (but that have not yet been introduced along the linear learning path) can be individually introduced at the exercise skill level via a) picture-mediated exercises that suggest the new word's meaning by pictorial context, b) written-language or spoken-language exercises that suggest the new word's meaning by verbal, written, and/or pictorial contextual clues.

In some versions of this embodiment, using linguistic patterns already introduced along the learning path would also not be the only option. Idiomatic expressions associated with the choice-word in the target language might also be introduced.

Within the context of a broader learning system, one preferred embodiment would add new user choice-words to the standard vocabulary word-banks associated with each point along the learning path. These new choice-words could then be incorporated at future points along the learning path by being drawn from the newly modified word bank to construct future exercises.

Along the same lines, another embodiment would add both the user choice-words as well as the words with a high-frequency association to the user choice-words. Using the dog example one more time, this would mean that, not only would “dog” be added to the word bank and used in future learning-path exercises, but words having a high-frequency association with “dog”—like “bark,” “run,” and “fur(ry)”—would also be added to the word bank for use in future exercises.

And some preferred embodiments would save the exercise sets as iconic exercises that could then be reselected and reworked by selecting from an iconic story bank or by re-entering the choice-word to recall a repeat of the same earlier exercise.

A preferred embodiment would allow the regeneration of an exercise set in the same statistical way that an earlier version of the set was generated from the same choice-word. This might not result in the exact same exercise as the prior one. But it would save considerably on memory.

In at least one embodiment of the present disclosure, an app for teaching a foreign language to a user proficient in a native language (a) tracks a current level of proficiency of the user in the foreign language, where the current level of proficiency increases with the proficiency of the user in the foreign language, (b) receives from the user a current word or phrase in the native language, and (c) generates a number of current exercises for the user to perform based on (i) a translation of the current word or phrase in the foreign language and (ii) the current level of proficiency of the user in the foreign language.

### BRIEF DESCRIPTION OF THE DRAWINGS

Reference herein to “one embodiment” or “an embodiment” means that a particular feature, structure, or characteristic described in connection with the embodiment can be included in at least one embodiment disclosed and claimed herein. The appearances of the phrase “in one embodiment” in various places in the specification are not necessarily all referring to the same embodiment, nor are separate or alternative embodiments necessarily mutually exclusive of other embodiments. The same applies to the term “implementation.” Embodiments of the disclosure will become more fully apparent from the following detailed description, the appended claims, and the accompanying drawings in which like reference numerals identify similar or identical elements.

FIGS. 1A-1C show various block diagrams via which a system of the disclosure could be delivered.

FIG. 2 shows a flow diagram of one preferred embodiment's workflow.

FIG. 3A is an illustration of a possible home screen for one embodiment of this disclosure.

FIG. 3B is an illustration of one possible screen for allowing users to enter a choice-word in their native language.

FIG. 4 is a partial example of a full, target-language dictionary for a native English speaker learning German for one embodiment of a low- or no-AI coded version of this disclosure.

FIG. 5 is an illustration of one embodiment of the linguistic patterns and language banks that could characterize a learning path.

FIGS. 6A-6I are illustrations of various embodiments of exercises that could be generated based on some embodiments of a language-learning system that employs user-choice-mediated exercises.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

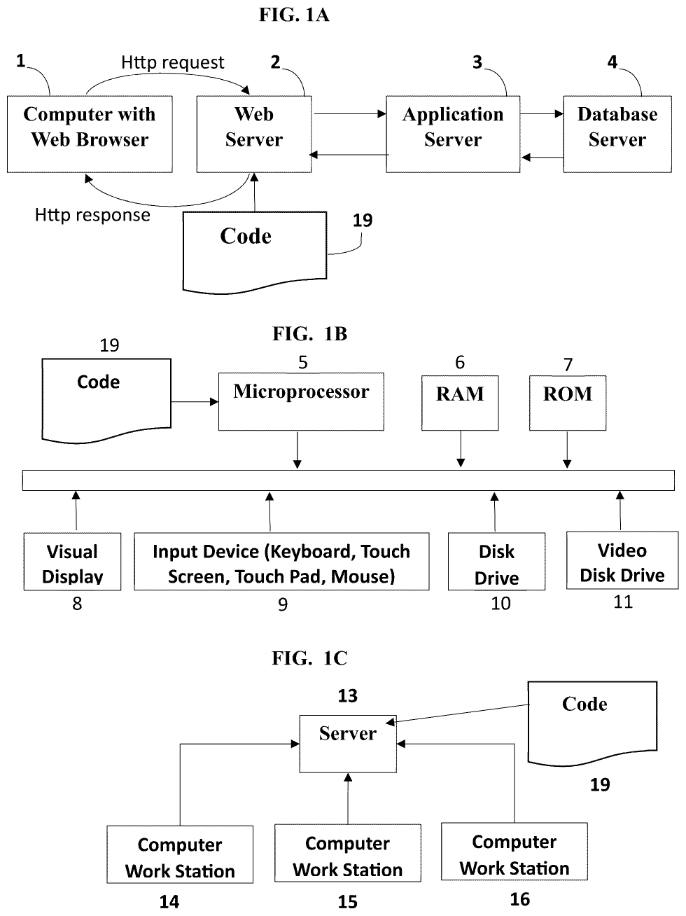

FIG. 1A is a block diagram of an online system. This system may comprise a machine-based computing device 1 operating a web browser with client-side processing capabilities. A web server 2 containing a browser-compatible, code-based aspect of this embodiment may supply that aspect to the computing device 1, assisted by an application server 3 and a database server 4 used to store statistics long-term. The code for this disclosure may be provided from memory (not shown).

This is only one embodiment among other possible embodiments. By way of example, stand-alone PC embodiments, as shown in FIG. 1B, and intranet embodiments, as shown in FIG. 1C, may also be used to allow use of an embodiment of this system.

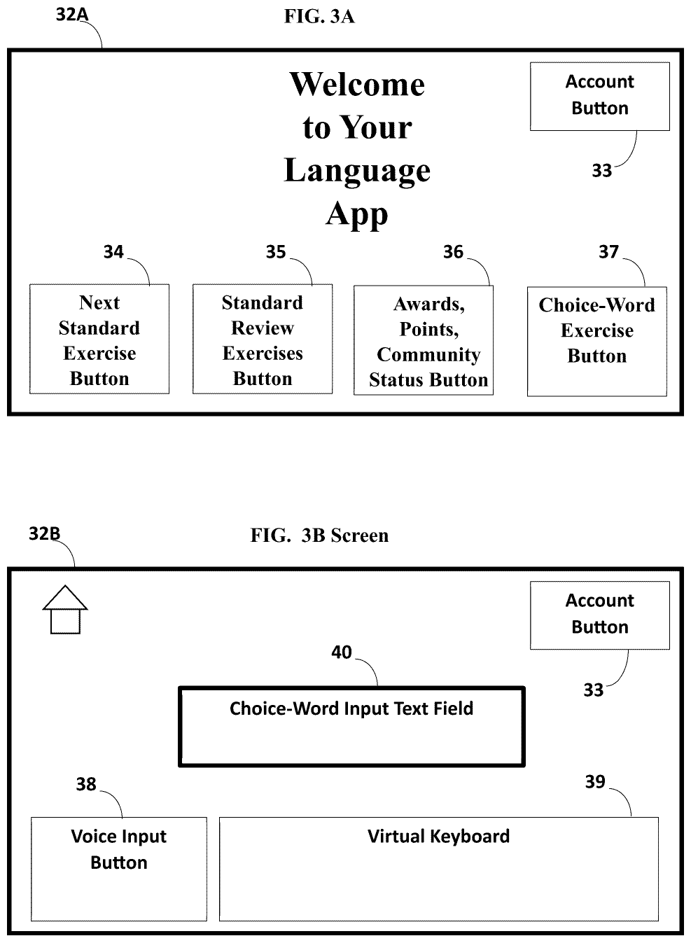

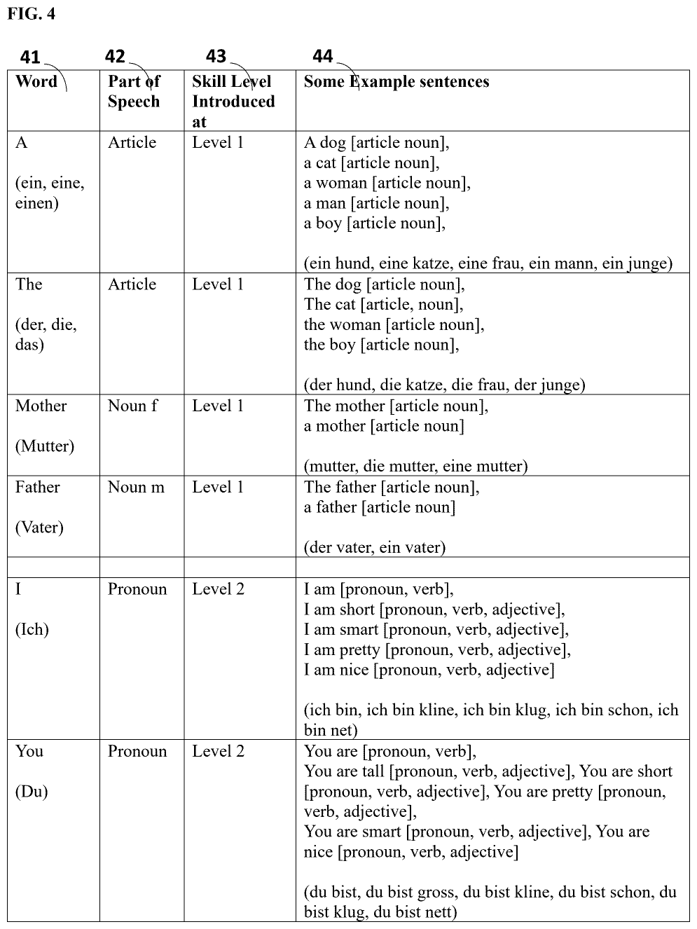

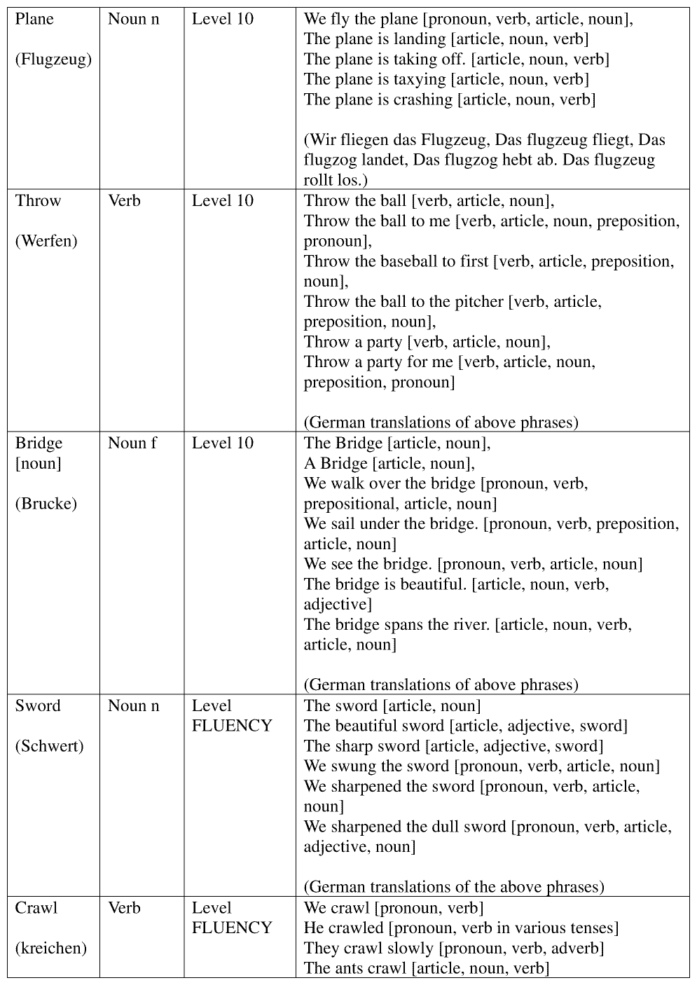

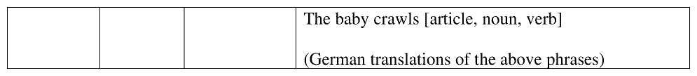

Referring back to FIG. 1A, a coded, interactive learning system 19 supplied by the web server 2 and in accordance with an aspect of this embodiment is shown in FIG. 1A. The online system 19, accessible via the web browser 1, may be configured to present an initial login screen 32A of FIG. 3A. This login screen 32A will allow access to account information 33, such as user name, email address, and other basic account information, the next-available user exercise 34 based on a linear learning progression, the review exercises 35 that are currently available to the user, and any awards 36 the user has won or their achievement relative to other community users.

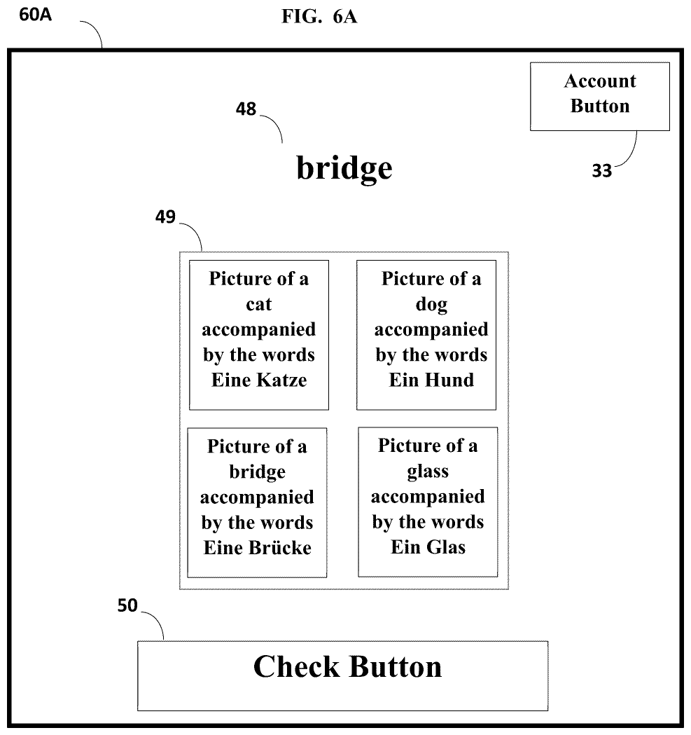

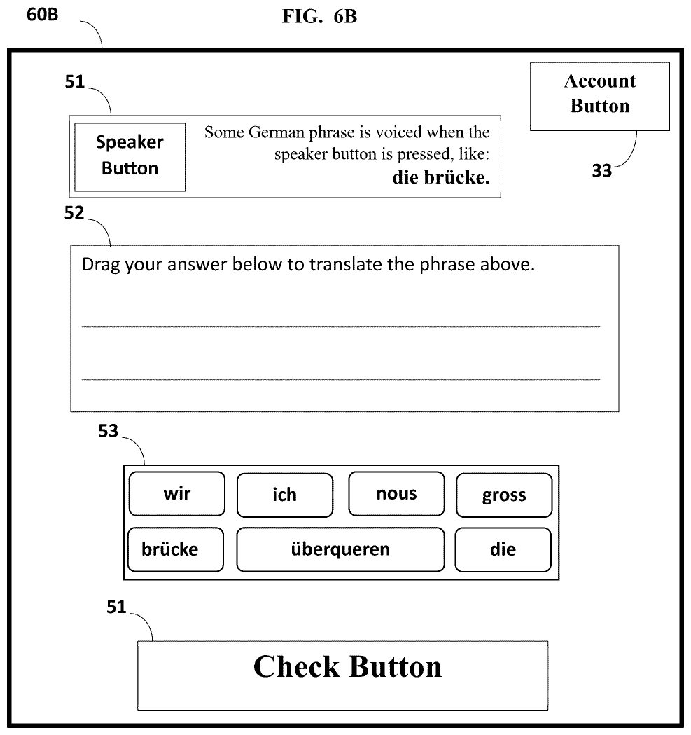

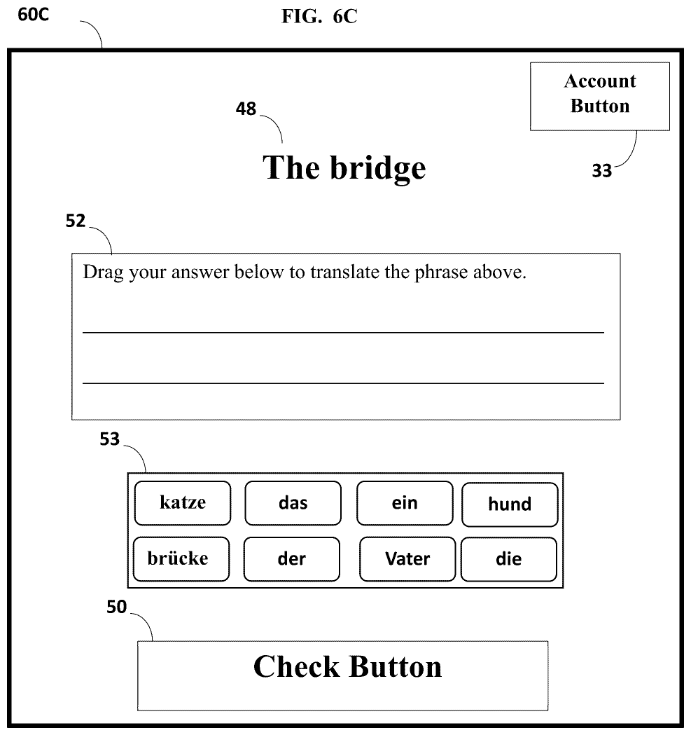

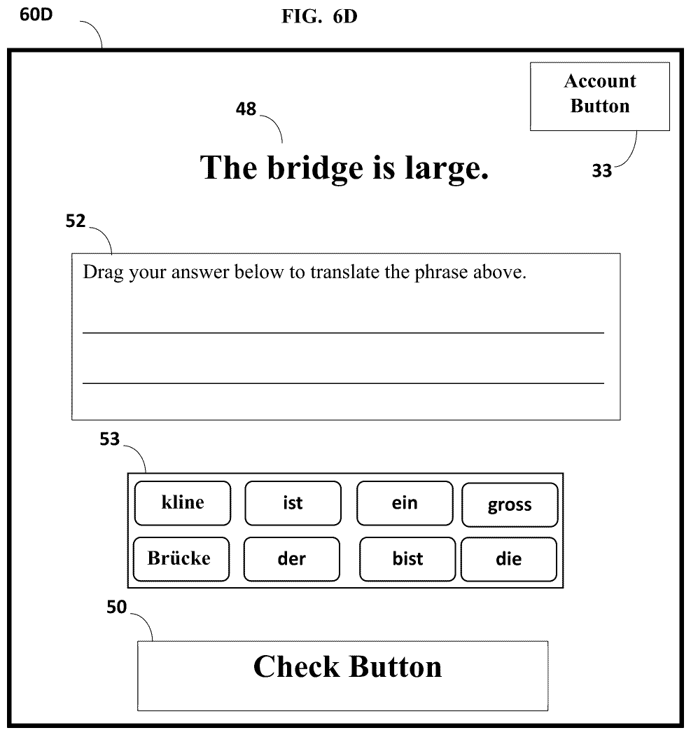

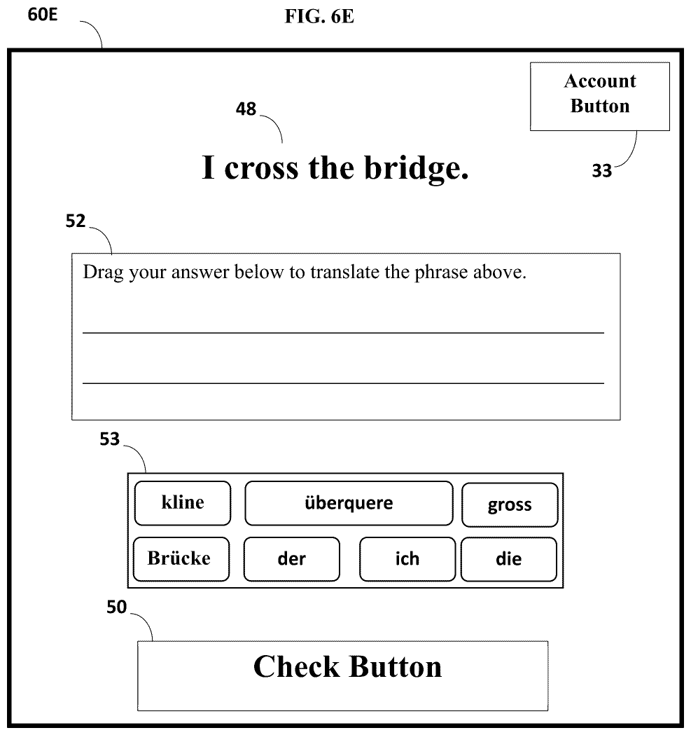

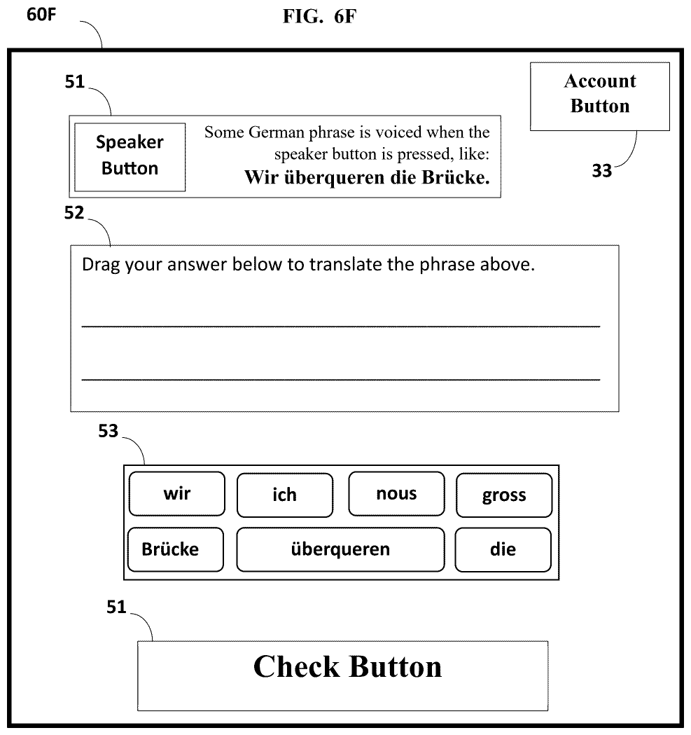

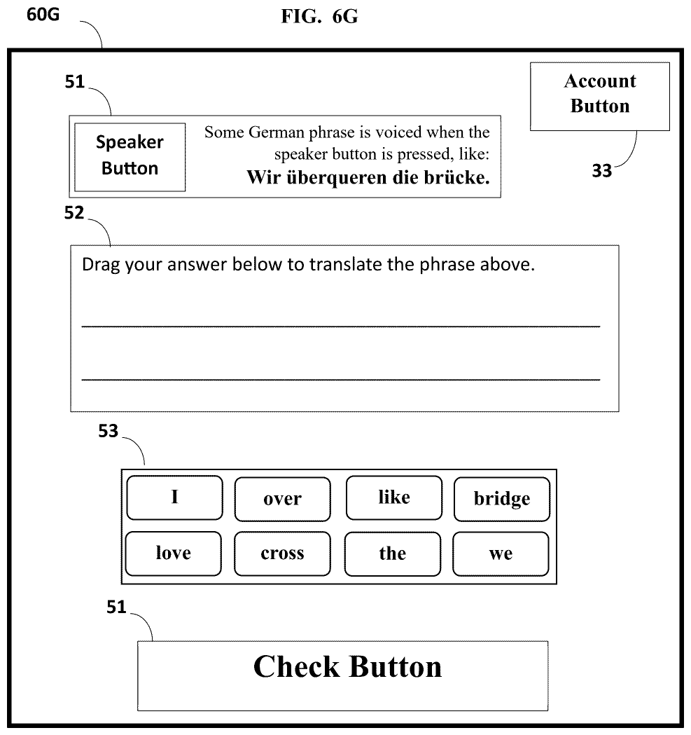

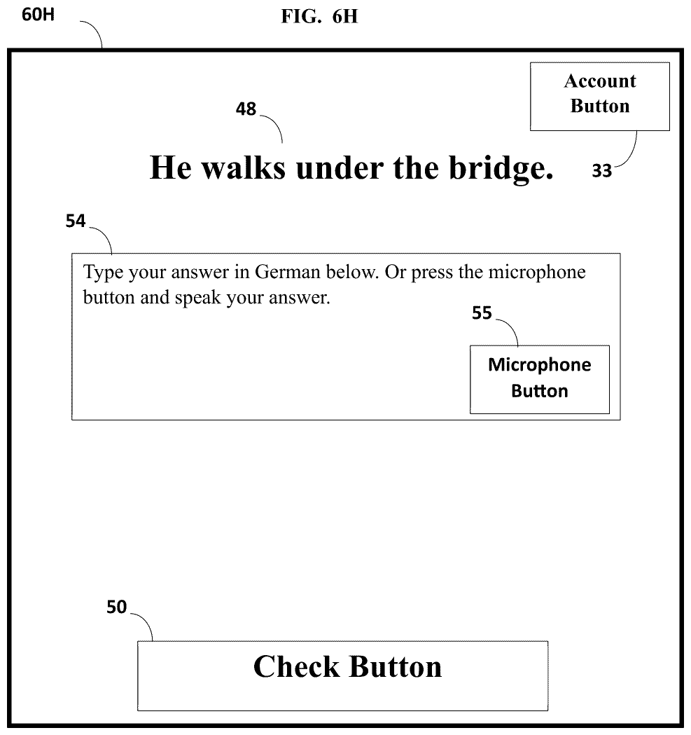

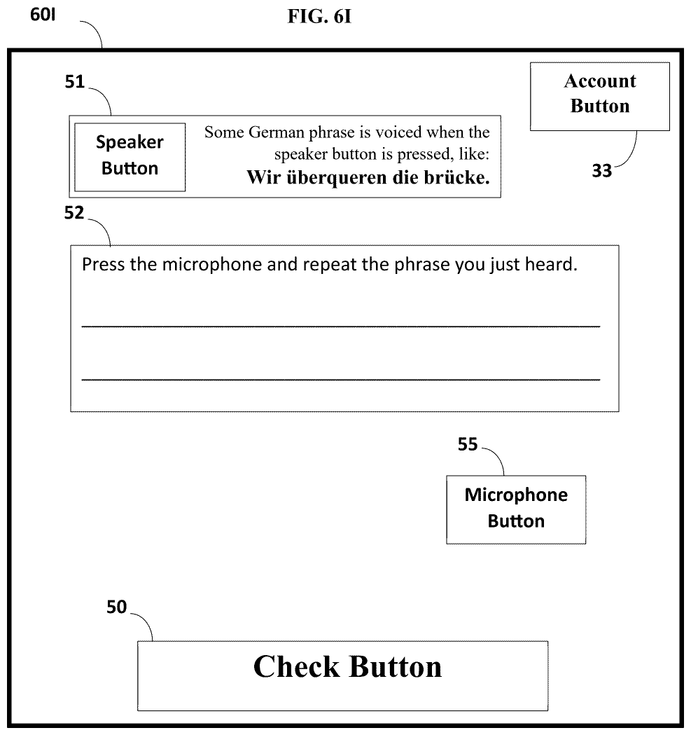

A preferred embodiment of a home screen should also contain a button 37 that allows access to the choice-world exercise screen, which is the gateway to the choice-word exercises, the main subject of this disclosure (see FIGS. 6A-6I). But other embodiments of this disclosure may place the choice-word exercise button 37 lower or higher in an app's screen hierarchy.

As previously described, some embodiments can operate on a web-based platform, a standalone PC platform, or an intranet platform. An example of a standalone computer platform is shown in FIG. 1B. This off-line system may use a computerized device requiring no connection to the internet in order to use the embodiment. The computer's microprocessor(s) 5, RAM 6, and ROM 7 may be used to run an offline version of software in accordance with the various aspects of the embodiment, with a visual display 8 available for viewing interface screens generated by this embodiment. This offline embodiment may also include one or more input devices 9 such as a keyboard, touch screen, touch pad, and/or mouse. Other embodiments might include and use disk drives 10 or video disk drives 11 to facilitate the use of the embodiment.

In accordance with an aspect of another embodiment, a local area network as shown in FIG. 1C may be used to allow users access to one embodiment of the learning system described herein. The local area network server 13 and the networked computer workstations 14, 15, 16 may be used in combination with each other to supply the computational, memory, displays, and input elements that may be used in an embodiment.

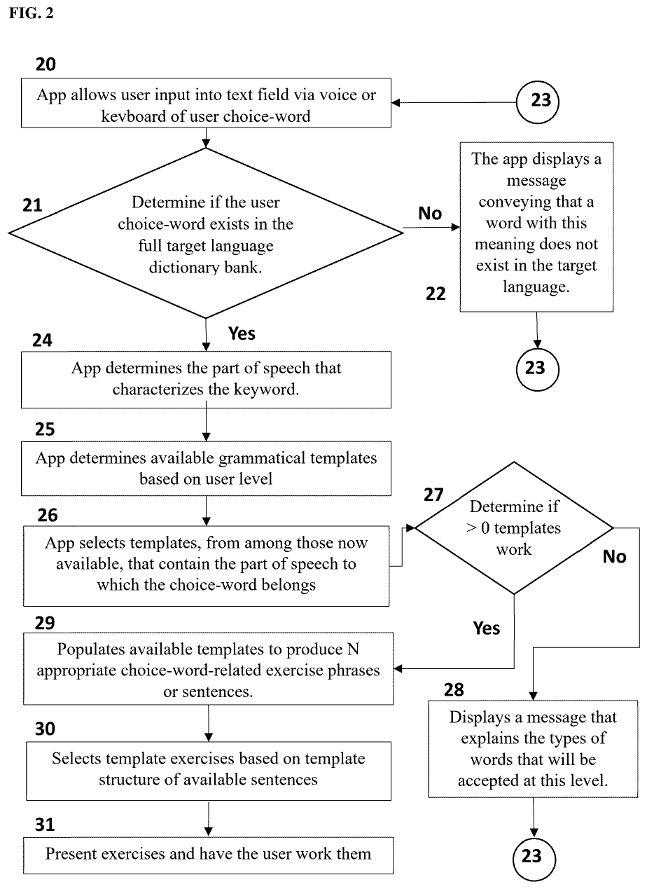

FIG. 2 shows one preferred embodiment of this embodiment's workflow once the app's screens have brought the user to a place where they can interact with the embodiment. Once this portion of the app is reached, in step 20, a screen will appear that allows a user to input a choice-word that they wish to learn about. The choice-word will be entered in the user's native language.

In step 21, that choice-word will be checked against a full dictionary of words stored in memory, whether instantiated in code 19, residing in the cloud on a server 3 or 4 of FIG. 1A, resident in RAM 6 or ROM 7 of FIG. 1B, or housed on an external memory device such as a disk drive 10 of FIG. 1C.

If the user's choice-word is not found in the full native-language-to-target-language dictionary in step 21, then, in step 22, a message will be displayed stating as much and asking, in step 23, if the user would like to enter a new word in step 20.

If the user choice-word is found in the full native-language-to-target-language dictionary, then, in steps 24-30, the app will use code to construct a set of native-language exercises that will allow the user to practice and acquire fluency with the associated choice-word in the target language. For a more granular description of these steps, see the detailed descriptions for steps 21-24 beginning in paragraph [0088], for step 25 beginning in paragraph [0096], for step 26 beginning in paragraph [00101], for step 27-29 beginning in paragraph [00107], and for step 30 beginning in paragraphs and [00145].

Once the system has executed these steps to construct a set of level-appropriate exercises centered around the user's target word, in step 31, the app will then present the exercises to the user so that they can practice and acquire fluency with the choice-word.

In one preferred embodiment, once the exercise is fully worked, the app will exit the choice-word exercise set and return to the home screen 32A of FIG. 3A. In another preferred embodiment, the app will exit the exercise set and return to the choice-word exercise screen 32B of FIG. 3B.

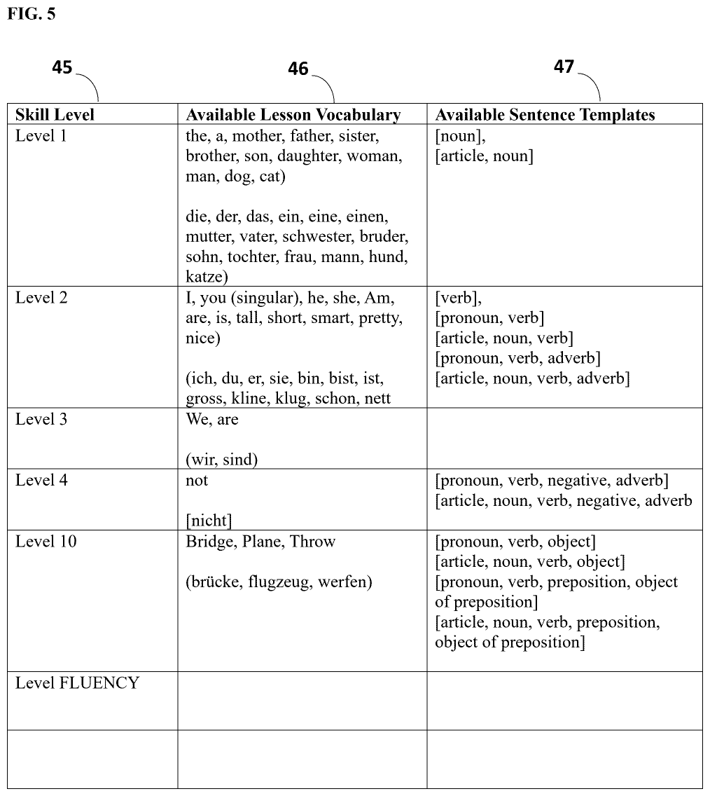

That is an overview of the workflow in one preferred embodiment of this disclosure. Other workflows are possible in other embodiments because the order of certain elements of this workflow can be changed. In still other embodiments, elements of the workflow can be left out and compensated for by adding additional informational columns to the language banks or linguistic patterns used in those banks. Or elements can be added to the workflow that require less detail to be included in the language banks and their linguistic patterns. See FIG. 4 for an example of a dictionary that could support some of these embodiments.

The remainder of this discussion will focus on the details of implementing each step of this workflow and the figures given to help illustrate the particulars of those details.

### Detailed Description of Step 20 of the Workflow of FIG. 2 Related to a Possible Choice-Word Exercise Screen of FIG. 32B

In step 20 of the workflow of FIG. 2 in a preferred embodiment of this disclosure, the word choice screen 32B of FIG. 3B provides the user the ability to enter a single keyword. In another embodiment, the user is allowed to enter two or more words, provided they have a single coherent meaning. For example, a user might enter the verb “walk” in the preferred single-word entry embodiment. But, in embodiments that allow multi-word entries, the app might also allow a user to enter the infinitive version “to walk.” In another possible version of this embodiment, the user might enter a single word as well as a second word, enclosed in parentheses, to describe the context in which the choice-word will be used. For example, “ball (tennis)” vs. “ball (dancing)”.

A multi-word entry system that uses parentheses or some other indicator to specify a context-word is one preferred embodiment of this disclosure.

Allowing multi-word entries with no context indicators introduces programming challenges related to deciding which word the user sees as key. One embodiment of the code could be configured to spot infinitives and reduce them to their primary verbal element.

FIG. 3B shows an input field 40, where the user can enter their choice-word or words. In some embodiments, the choice-word(s) can be entered by typing directly from a keyboard, touch screen, touch pad, or mouse.

In one preferred embodiment of this disclosure, a dedicated virtualized keyboard 39 is included because it can easily be configured to include special characters that are unique to the user's native language. On touch screens, the user can use this virtualized keyboard 39 by tapping desired keys. On non-touch screens, the virtualized keyboard 39 can be used by via a mouse by moving a pointer to the desired keys. A mouse-click can then be used to select the desired character-key. In the same preferred embodiment, input may also be entered via a voice prompt initiated by a voice input button 38. Hitting the enter key on a keyboard 9 (FIG. 1B) or virtualized keyboard 39 would signal the system to move to the next step in the app workflow.

### Description of FIG. 4 as Relates to Workflow in FIG. 2

FIG. 4 is a partial illustration of one possible embodiment of a Full Target language dictionary. Most such embodiments should contain, at a minimum, a native language word column 41 and a skill-level column 43. The “Word” column 41 in preferred embodiments would contain most words in the native language, with or without their target language translation. The “Skill Level” column 43 would contain the levels at which each word is introduced along the language learning path. In preferred embodiments, each word's language level is based on target language considerations such as frequency of occurrence in everyday language, instructional methodological considerations, and user learning goals. For example, high-frequency words might be assigned a higher priority (level 1) and introduced earlier in the course. Lower-frequency words might be assigned a lower priority and introduced later in the course. The “Part of Speech” column should contain at least one part of speech characteristic of the way in which the word is generally employed.

Column 44 is not an actual part of most preferred embodiments of a learning language dictionary. It is provided mainly to show how a full target-language dictionary could be employed to populate level-appropriate syntactical structures, either before or after translation into the target language. Importantly, in various embodiments of such dictionaries, column 42 might or might not be included because appropriately trained large language models would generally already contain access to parts-of-speech information. Though such language models would likely also be able to infer learning levels, preferred embodiments of such dictionaries should contain this column so as to allow programmers/instructors to retain tighter control over the structure of a user's language learning journey.

In a preferred embodiment of this disclosure, once a user has entered a single word-choice in their native language, a coded method or set of methods will then be used to determine if the user choice-word exists in the full target-language dictionary stored in memory for the native and target languages.

FIG. 4 is an illustration of a portion of an embodiment of one such dictionary that might be used for an embodiment of an app. Embodiments of such dictionaries could contain the majority of the words in both the native language as well as their target-language translations. Other embodiments might contain only one or the other-native language only or target language only.

These latter embodiments could rely on AI to also translate the choice word into the target language and then work from leveled dictionaries composed solely or primarily of target-language words, phrases, and syntactical structures. Or, the dictionary might be composed only of native language entries, relying on AI to bridge the gap between native-language and target-language words, phrases, and syntactical structures.

Regardless of the approach, this contrasts with most language apps that generally teach a far smaller subset of the total words available in the target language. For instance, mastering eight hundred words in a target language is generally enough to allow a speaker to function reasonably well in everyday settings. Therefore, an embodiment of a language-teaching app might include only those eight hundred words, barely one percent of the words a person fluent in the target language will have mastered.

Other embodiments of a language-teaching app might have much larger dictionaries, but still nothing close to one hundred percent of the words required for fluency.

In a preferred embodiment of this disclosure, the target language dictionary will include as close as possible to one hundred percent of the highest-frequency words required for full fluency.

### Description of FIG. 5 as Relates to Workflow in FIG. 2

As mentioned earlier, in preferred embodiments of this disclosure, skill levels are attached to individual words based on various pedagogical concerns. Increasing skill levels are also associated with increasingly complex syntactical structures. FIG. 5 shows an example of how Skill Levels 49 are paired with increasingly complex syntactical templates 51. In preferred embodiments of this disclosure, knowing the syntactical structures associated with a given level ensures users are not presented with exercises that exceed their ability to comprehend and so benefit from.

To understand the structure of these full-language dictionaries and how they are employed in this disclosure to automate the generation of level-appropriate exercises that fall outside the scope of a standard, linear-language-learning pathway, a person should consider what an embodiment of such a pathway and its associated syntactical structures might look like if it was written out in table form. FIG. 5 illustrates one such embodiment.

In the preferred embodiments of most language apps, new language and grammatical structures are introduced in successive skill levels. As a loose generalization, the highest-frequency words and easier grammatical structures are introduced at lower skill levels. Lower-frequency words and more-complicated grammatical structures are introduced at successively higher skill levels. This continues until the user has traversed every skill level of the linear learning path represented by a language-learning app.

In this example of the language banks and grammar patterns that characterizes one embodiment of a learning path of FIG. 5, the first learning skill level is level 1. The last standard learning skill level where specific exercises are provided by the learning pathway is level 10. In standard learning apps, no words beyond that would be taught and the app's learning journey would be complete. But the learning path illustrated by FIG. 5 also displays a skill level titled “FLUENCY.” This level includes all the remaining target-language words and their translations that are not specifically covered by a standard learning path but which are still required for fluency.

For instance, the words “sword” and “crawl” are not high-frequency words in the everyday conversation of most languages. So, a traditional version of a language-learning-app pathway might not include them or some of the various words or phrases associated with them.

This embodiment functions by structuring a method by which low-frequency words that are more typically employed by high-fluency users (or even standard-learning-path words) that are highly useful or interesting to the user can be acquired outside the standard linear sequence of a learning path. This embodiment, aided by harnessing the level-organized elements of an application's learning path, maximizes user interest and language acquisition by ensuring the resulting exercises are level-appropriate for each individual user.

For instance, in the learning path embodied by FIG. 5, a user who is on level 1 may be about to fly to London. They can use this embodiment to enter the level-10 word “plane” to generate an exercise set of high interest to them that is nonetheless pitched at an appropriate app learning level, in this case, exercises designed for a level-1 syntactical user.

The basic idea here is that words can now be acquired outside the standard linear sequence when they are of greatest concern to the user and interest is highest. Level-2 students can learn high-interest words from level 8 or the fluency skill level. And level-10 students can decide if they want to review a specific word from level 4. This embodiment makes such out-of-sequence but grammatically (syntactically) level-appropriate learning easily possible.

It is important to note that, in some embodiments, an actual, coded learning-pathway data structure might not explicitly exist anywhere in the coded embodiment of some language-learning apps. In some apps, such a learning pathway exists simply as an artifact of the fact that words and grammatical structures are introduced sequentially and, if the sequence of introductions is noted and recorded, it would present as a chart similar to the one of FIG. 5 just used here for illustrative purposes.

In some embodiments, the degree to which an actual, coded, language-learning pathway's data structure will be visible in memory depends on the degree to which that structure is taken for granted by virtue of being invisibly embedded in the statistical links that make up the AI large-language models that are becoming increasingly central to many language-learning apps.

In an embodiment where the instructional levels reside mostly within an AI's statistical links, it would be useful to ask the AI to list its own description of how it organizes its learning-path levels. Then the coder could use that instance of a learning path to configure the application to construct level-appropriate, user-choice exercises.

Description of FIG. 4 as Relates to Workflow in FIG. 2, Continued

An observer can see that preferred embodiments of a full-language dictionary derive the skill-level data associated with each of their individual word entries from the skill level at which it is introduced along its associated language-learning pathway. The level associated with any given word is the level at which it first appears in the linear, language-learning pathway just explained as in FIG. 5.

With that learning-pathway structure in mind, it makes sense that, for full-language dictionaries like those embodied in FIG. 4, words introduced earlier along the learning pathway will have lower learning-level numbers. Words introduced later will have higher learning-level numbers.

Understanding where learning-levels come from and how they are associated with increasing degrees of grammatical (syntactical) complexity but decreasing degrees of word frequency, hierarchical dictionaries like in FIG. 4 can now be used to show how a preferred target-language dictionary would be used in steps 21-24 of FIG. 2 of one embodiment of this disclosure's workflows.

### Detailed Description of Workflow Steps 21-24 in FIG. 2

To begin an example of this aspect of one embodiment of this disclosure, assume a user entered the choice-word “plane.” Once an enter button or key is then pressed, a coded method would take the user's choice-word and compare it to successive native-language entries in column element 41 of FIG. 4, titled “Word”.

If no match was found in column element 41 in step 21 of FIG. 2, then the app would move to workflow step 22. The app would display a message and either return to one of the two screens 32A and 32B of FIGS. 3A and 3B, respective, to allow the user another chance to enter a choice-word or move to another lesson choice.

If a match is found in column element 41 in step 21 of FIG. 2, then the app would move to workflow step 24 to determine what part of speech the choice-word belongs to. For nouns, this part-of-speech information would also include the noun's gender in some embodiments, where “f” indicates feminine, “m” indicates masculine, and “n” indicates neuter.

In this example, column 42 of FIG. 4 would indicate that the word “plane” is a noun that is neuter in the target language.

In some embodiments, the target language would not require a gender determination, and this information would not be present in the full-language dictionary. In other embodiments, a noun is “gendered” based on whether it is animate or inanimate. In still other embodiments, there can be up to twenty different “gender” classes. Regardless of the embodiment, the way in which gender information is quantified would be dependent on the number of genders required by the target language.

In AI-mediated versions of this disclosure, the gender might or might not be indicated in the full dictionary because that information could reside within the AI model.

Also, other embodiments of this disclosure might include information on the transitive, intransitive, reflexive, or other verb characteristics. In still other embodiments, other characteristics of other parts of speech might be helpful to indicate in column 42 of FIG. 4 or elsewhere.

### Detailed Description of Workflow Step 25 in FIG. 2

Having determined the choice-word's part of speech and gender, or other pertinent attributes, if necessary, this would then bring us to step 25 in the workflow of FIG. 2. In step 25, the app determines the available grammatical templates appropriate for the language learning-path level the user is currently on.

In the embodiment of this disclosure represented by the FIG. 5 learning path, a user at skill-level 1 would have a limited number of grammatical templates available. As seen in column 47 of FIG. 5, the templates would be:

| | |
|---|---|
| [noun] | level 1, |
| [article noun] | level 1. |

A user at skill-level 4 would have all templates available in column 47 up to and including those at level 4. In this case, that would include all the available templates from levels 1, 2, 3 (none in this case), and 4. As seen in column 47 of FIG. 5, the templates would be:

| | |
|---|---|
| [noun] | level 1, |
| [article, noun] | level 1, |
| [verb] | level 2, |
| [pronoun, verb] | level 2, |
| [article, noun, verb] | level 2, |
| [pronoun, verb, adjective] | level 2, |
| [article, noun, verb, adjective] | level 2, |
| [pronoun, verb, negative, adjective] | level 4, |
| [article, noun, verb, negative, adjective] | level 4. |

These two examples provide a clear illustration of why a student operating at a lower skill level could be easily lost if a higher-level exercise with a more-complex grammatical structure was supplied during a choice-word exercise. The language input supplied by such a lesson would cease being comprehensible to most students and the learning value of the lesson would be lost.

### Detailed Description of Workflow Step 26 in FIG. 2

Having 1) a choice-word that has been determined to reside in the dictionary, 2) the part of speech that choice-word belongs to, and 3) a set of available grammatical templates that are level-appropriate for the user at that point along his or her learning path, a preferred embodiment of this disclosure (as illustrated in the FIG. 2 workflow) then determines in step 26 which grammatical templates can be used with the user's choice-word.

In one embodiment based on this example, a method would be employed that was coded to search for all the templates that were determined as level-appropriate in workflow step 25 that contain the part of speech to which the user choice-word belongs. This subset of grammatical templates would then be stored in memory and used for constructing the exercises to come.

In another embodiment of this disclosure, it has to be acknowledged that any lesson set that is restricted to templates containing only the part of speech to which the choice-word belongs might have limited flexibility. For instance, suppose the user choice-word was “plane”. In such an embodiment, it might be useful to include grammatical templates and their associated exercises that match parts of speech for words related to the user choice-word. For example, the word “plane” indicates that the verbs “land”, “taxi”, “takeoff”, and “crash” are related to “plane”. In many embodiments, it might be useful to make sure to include grammatical templates that deal with verbs in the absence of the target noun.

Therefore, some preferred embodiments of this template would allow the subset of templates selected for to include the parts of speech characterizing both the choice-word and related words belonging to one or more other parts of speech.

In some of these preferred embodiments, at least one determining factor as to what parts of speech would be used to extend the choice of templates would be whether or not the related word has already been introduced in the learning sequence. In other embodiments, the determining factor might be whether a related verb was irregular or not. In still another embodiment, the determining factor might depend on noting if the plural form of a related noun was irregular. And so on.

### Detailed Description of Workflow Steps 27, 28, and 23 in FIG. 2

Having selected a subset of available grammatical templates in a preferred embodiment represented by the workflow in FIG. 2, it is now time for the app to determine if that subset contains zero elements or one or more elements.

For example, a level-1 user might choose to practice the word “throw”, which is a verb. Unfortunately, looking at the available level-1 templates in our example learning-path language bank, only [noun] and [article, noun] templates are currently available. See column 47 of FIG. 5. Because “throw” is a verb, in various embodiments of this system that allow only templates with parts of speech that match the choice-word's part of speech, the embodiment would have selected a subset of zero templates. This would cause such an embodiment to display an error message explaining the types of words that are appropriate for this level in step 28 of FIG. 2, and then offer the user a chance to amend their choice-word in step 23.

Other embodiments of this disclosure might make other workflow choices at this juncture. This is simply one preferred example of a possible embodiment for illustration purposes.

### Detailed Description of Workflow Steps 27-29 in FIG. 2

Having selected a subset of available grammatical templates in a preferred embodiment represented by the workflow in FIG. 2, if the subset of selected elements contains one or more templates in step 27, then it is now time for the app to populate those templates in step 29.

Many different ways of populating those templates are possible resulting in many possible embodiments of this disclosure. This portion of the detailed description will include a preferred embodiment along with a partial example of the structure of such an embodiment of a full-language dictionary necessary to support those choices. As mentioned earlier, the choice of embodiments at this juncture will largely depend on how AI is employed in an embodiment to populate the chosen templates.

Some preferred embodiments would use a large-language AI model configured to populate these templates. In this case, the model would access 1) the available templates, 2) the choice-word and its part of speech, 3) the set of all words at or below the skill-level of the user as read from the language-learning path in column 46 of FIGS. 5, and 4) all words (and their part-of-speech info) that are part of the full-language dictionary that are specifically related to the user choice-word.

In a code-intensive preferred embodiment, if an English-to-German user at level 2 entered the choice-word “plane,” the available templates might be:
[noun],
[article, noun],
[verb],
[pronoun, verb],
[article, noun, verb],
[pronoun, verb, adverb],
[article, noun, verb, adverb],
[pronoun, verb, negative, adverb],
[article, noun, verb, negative, adverb].

The choice-word would then be used to populate those templates by coding a method to do a direct substitution into these templates where appropriate:
[plane],
[article, plane],
[verb],
[pronoun, verb],
[article, plane, verb],
[pronoun, verb, adverb],
[article, plane, verb, adverb],
[pronoun, verb, negative, adverb],
[article, plane, verb, negative, adverb].

Closely associated words such as “land”, “takeoff”, “taxi”, and “crash” could then be substituted using a second coded method, resulting in a set that looked something like:
[plane],
[article, plane],
[land],
[pronoun, land],
[article, plane, taxi],
[pronoun, taxi, quickly],
[article, plane, flies, quietly],
[pronoun, flies, negative, quickly],
[article, plan, lands, negative, quietly].

Finally, words from skill levels lower than or equal to the user's current skill level from column 46 of the language-learning path of FIG. 5 could be substituted to fill in the remaining words:
[plane],
[the, plane],
[land],
[I, land],
[A, plane, taxi],
[It, taxi, quickly],
[The, plane, fly, quietly],
[He, flies, negative, quickly],
[The, plane, lands, negative, quietly]

Once the templates have been populated by the various coded methods mentioned above, in this embodiment, the templates would then be fed into a large-language model configured to translate each filled template into a legitimate, grammatically correct phrase of sentence in the target language.

As an example of the effectiveness of this preferred embodiment, the following ten sentences were constructed using ChatGPT in just this manner. After feeding ChatGPT the desired templates and target words, the model returned the following output.
1. [plane]→[Flugzeug]
2. [the, plane]→[das Flugzeug]
3. [land]→[landen]
4. [I, land]→[Ich lande]
5. [A, plane, taxi]→[Ein Flugzeug taxi]
6. [It, taxi, quickly]→[Es taxiert schnell]
7. [The, plane, fly, quietly]→[Das Flugzeug fliegt leise]
8. [He, flies, negative, quickly]→[Er fliegt nicht schnell]
9. [The, plane, lands, negative, quietly]→[Das Flugzeug landet nicht leise]

Building such a system could be quite labor intensive for several reasons.

First, the full-language dictionaries necessary to support the full languages would have to be built with care. An AI large-language model could be used to construct such a dictionary in short order. The result could then be stored in memory and used in the fashion just described.

Even then, another shortcoming remains if a programmer decides to employ traditionally coded methods for substituting into the templates while selecting from the appropriate pools of words. Unfortunately, it is possible to generate sentences that, although grammatically correct and correctly leveled, do not make full sense.

In the last example, the app would easily have ended up with a template filled like this: [The, plane, crash, quietly] from the template [article, noun, verb, adverb]. The resulting sentence fails to make real-world sense in either the native or target language.

In some embodiments of this disclosure, the app could use a large-language AI model to eliminate any resulting sentences that fail to make sufficient sense.

Given the current power of these models, it makes sense to employ AI on the front end in making reasonable substitutions rather than eliminating unreasonable results on the back end. So, in one preferred embodiment of this disclosure, the app could supply the AI the templates. Then, the app could ask the AI to use those templates to construct a set of real-world sentences from these pools of words that make the most real-world sense.

In still another preferred embodiment, one making ambitious use of AI's capabilities, the app could supply the level-appropriate group of templates, the available level-appropriate vocabulary words from the learning-path's column 46 of FIG. 5, and the user's choice-word. Then, the app could use its AI capabilities to construct native-language sentences that have the highest probability of occurrence in the real world while maximizing these limiting parameters.

Within properly trained, large-language models, the probability that verbs like “taxi”, “fly”, and “land” will be statistically associated with “plane” is extremely high. Because that statistical knowledge is native to a trained AI model, large, cumbersome full-language dictionaries that are hard to construct could be mostly or completely dispensed with in some versions of a preferred embodiment.

There is an important caveat to this entire discussion of grammatical templates and substitutions. At least in the early stages of a native English speaker learning German, the grammatical templates in the native language parallel most translations in the target language. This is not true for all native-target language pairs. In some of those pairs, the distance between a native-language grammatical structure and the target-language equivalent can be quite substantial even in the earliest learning stages. For example, in German, once verb tenses other than the present tense are introduced, grammatical structures can differ radically between languages.

To compensate for this potential distance, in some embodiments, the coder might make the decision to map the target-language templates onto the native-language equivalents before substituting into those templates. In some embodiments, like the one described by this example, the coder could choose to include a keyword (like “negative”) to signal that the English versus German structure will differ. In still other embodiments, the coder might choose to translate the native-language words into their target equivalent before substituting them into a now native-language syntax template.

The one thing to be said in all of this is that, prior to the advent of AI large-language models, smoothing out the differences between what has been substituted in and the grammatically correct, target-language equivalent finally delivered on the other end would have been considerably more code-intensive, to the point of likely having to be accounted for by a) programming a new set of translation methods for each language pair or b) picking a central language through which all translations would be piped, and then creating methods to facilitate piping to and from that language.

With the advent of AI large-language options, models can now be trained to circumvent this need for an army of language-specific methods to ensure grammatically correct translations between the native-language or target-language approximations that result after substitution and the resulting grammatically correct equivalent sentences in the target language.

### Detailed Description of Workflow Step 30 in FIG. 2

Having a set of target-language words, phrases, and sentences now available in the target language, it is time to use them to construct an actual exercise set in step 30 of FIG. 2.

Several considerations arise at this point in all preferred embodiments, considerations like how many exercises to include in a generated exercise set, which of the available grammatical templates to use when building a set, and how best to map each template onto the most-appropriate possible exercises for learning the target vocabulary or mastering the grammar that characterizes each sentence.

These are pedagogical decisions the answers to which will vary from embodiment to embodiment. In one preferred embodiment, the number of problems in a user-choice-generated exercise set should match the number of problems in a language application's standard problem set. If a standard set has ten problems in it, then so should the user-choice-generated set.

Regarding which exercises to use, some embodiments may choose to randomly select from among the available grammatical templates until the selections equal the required number of problems in a set. Some embodiments may select from the least-complex available templates to the most-complex, returning to the beginning to repeat that procedure until the selections equal the required number of problems in a set. The procedure would prioritize emphasizing the basics of a language over the complexities. Or that process could be reversed, selecting from the most-complex templates and moving to the least-complex ones, to prioritize quick mastery of newer grammatical structures.

In this example of one preferred embodiment, the selection process takes place from simpler templates to more-complex ones until the number of selected templates equals the maximum number of problems in an exercise set. This choice is based on the belief that new vocabulary is best mastered using less-complex grammatical structures so as to allow more cognitive resources to be allocated to remembering the vocabulary rather than to handling a challenging grammar structure that is not already a part of an application's standard learning-path sequence.

As for how to think about mapping grammatical templates onto available exercises such as those illustrated by FIGS. 6A-6I, here are a few examples to explain why the question of template-to-exercise mapping is important and to elucidate a few guiding principles.

Suppose the template [article, noun] has been used to generate the phrase “die brücke.” If brücke, or bridge, is the choice-word, and this is one of the first problems in the set, it makes sense to map this phrase to the very basic exercise template of FIG. 6A (to introduce the word) and the template of FIG. 6B (so the user can hear the word pronounced properly). These two templates are ideal for introducing noun, article-noun, verb, pronoun-verb, and other rudimentary constructions.

FIG. 6C shows another possible exercise variation using a phrase or sentence generated from a template syntactical structure. Here, element 57 is populated with level-appropriate word choices as well as word choices related to the user's choice-word. The user can drag in blocks from element 57 to construct the correct answer in element 56. FIGS. 6D and 6E show similar exercises but used with increasingly complex syntactical structures, each one appropriate for users further along their learning path journey and so capable of handling increasingly more syntactically demanding exercises.

The preceding exercises are primarily reading and writing exercises. The exercise of FIG. 6F displays one possible embodiment of a listening exercise. The user can press the button in element 55 to hear a spoken version of the target-language phrase generated from a syntax template at or below the user's skill level. Then the user can drag in blocks from element 57 to construct the phrase they have just heard. Uberqueren means “to cross over.” At this point in the learning path, it will be new vocabulary for the user. But because the syntax template used to introduce it is at the appropriate user level, the lesson will remain comprehensible to the user, allowing them to work with the new word in a manner that will optimize the assurance it is learned. FIG. 6G shows a similarly leveled lesson, but one which asks the user to translate what they have heard by dragging the appropriate blocks from element 57 into element 56 and then checking their answer by pressing the check button 54.

FIGS. 6H and 6I show several other possible exercise templates into which phrases generated from level-appropriate templates can be funneled. FIG. 6H shows a lesson where the template phrase from the native language will need to be typed out directly into the answer space 58 or spoken after pressing a microphone button so that the device can transcribe the answer into the answer space 58. Note that, in this case, the AI large-language model might be supplying the native-language phrase first, then translating that phrase into the target language. Or the model might be generating the target-language phrase first and then translating that phrase back into the native language for use in element 52 of this exercise. FIG. 6I is a variation on such an exercise in which the user will be asked to speak the phrase they just heard and the system will transcribe the spoken target-language phrase into element 55 before using the check button 50 to check the answer.

Whether or not each generating template is saved in memory with the resulting sentence (a preferred embodiment), or an AI is used to infer the template used to generate the phrase (another possible embodiment), the preferred method of mapping a phrase or sentence to an exercise template is via its associated grammar template.

If this same simple template and its next associated phrase appeared again later in the exercise set, then it might make more sense to map this phrase to one of the more-complex exercise templates, like in FIGS. 6C-6I.

In this example of a preferred embodiment, exercises like those in FIGS. 6H and 6I, where the user is asked to fully generate output in the target language, should be reserved for grammar templates that are mapped late in the exercise set. This is because, in the sequence of acquiring a new language, production is generally viewed as the final step after listening. The drag-and-drop exercises are quasi-production exercises, and therefore function better as intermediate exercises.

### Detailed Description of Workflow Step 30 in FIG. 2

In preferred embodiments of this disclosure, the exercises should be presented in the order they were generated. Whether or not to allow a user to revisit an incorrectly answered problem will depend on what choice was made in an application's standard problem sets. Some preferred embodiments of this disclosure will match the preferences of the applications in which they are embedded. But other embodiments might embrace other approaches.

In preferred embodiments of this disclosure, upon exercise completion, the generated exercise can then be stored in memory as an iconic exercise that can later be accessed via the standard exercise button 35 of FIG. 3A. In other embodiments, memory can be saved by storing the iconic exercise using only the name of the choice-word. The next time a user desires to repeat this exercise, the system could use the processes just discussed to regenerate and present a similar exercise set without having to go back to the choice-word exercise button 37 of FIG. 3A and make a new entry.

Although not explicitly shown in the figures, each node in the figures has at least one processor (e.g., a CPU) for processing incoming and/or outgoing data, memory (e.g., RAM, ROM) for storing data and (in some implementations) program code to be executed by the processor, and communication hardware (e.g., transceivers) for communicating with one or more other nodes.

In certain embodiments, the present disclosure is an apparatus for teaching a foreign language to a user proficient in a native language, the apparatus comprising a memory and at least one processor connected to the memory and operative to cause the apparatus to (a) track a current level of proficiency of the user in the foreign language, wherein the current level of proficiency increases with the proficiency of the user in the foreign language; (b) receive from the user a current word or phrase in the native language; and (c) generate a number of current exercises for the user to perform based on (i) a translation of the current word or phrase in the foreign language and (ii) the current level of proficiency of the user in the foreign language.

In at least some of the above embodiments, higher levels of proficiency in the foreign language are associated with syntaxes of greater complexity.

In at least some of the above embodiments, one or more of the current exercises comprise sentences in the foreign language containing the translation of the current word or phrase.

In at least some of the above embodiments, the apparatus is configured to maintain, for the user, a user database of words and/or phrases contained in previous exercises; and generate one or more of the current exercises based on at least some of the words and/or phrases in the user database.

In at least some of the above embodiments, the apparatus is configured to add the current word or phrase to the user database.

In at least some of the above embodiments, the apparatus is configured to independently include at least one new word or phrase in at least one of the current exercises, wherein the at least one new word or phrase is related to the current word or phrase received from the user.

In at least some of the above embodiments, the apparatus is configured to add the at least one new word or phrase to a user database for the user of words and/or phrases contained in previous exercises for the user.

Unless explicitly stated otherwise, each numerical value and range should be interpreted as being approximate as if the word “about” or “approximately” preceded the value or range.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure.

What is claimed is:

1. Apparatus for teaching a foreign language to a user proficient in a native language, the apparatus comprising a memory and at least one processor connected to the memory and operative to cause the apparatus to:
track a current level of proficiency of the user in the foreign language, wherein the current level of proficiency increases with the proficiency of the user in the foreign language;
receive from the user a current word or phrase in the native language; and
generate a number of current exercises for the user to perform based on (i) a translation of the current word or phrase in the foreign language and (ii) the current level of proficiency of the user in the foreign language.

2. The apparatus of claim 1, wherein higher levels of proficiency in the foreign language are associated with syntaxes of greater complexity.

3. The apparatus of claim 1, wherein one or more of the current exercises comprise sentences in the foreign language containing the translation of the current word or phrase.

4. The apparatus of claim 1, wherein the apparatus is configured to:
maintain, for the user, a user database of words and/or phrases contained in previous exercises; and
generate one or more of the current exercises based on at least some of the words and/or phrases in the user database.

5. The apparatus of claim 4, wherein the apparatus is configured to add the current word or phrase to the user database.

6. The apparatus of claim 1, wherein the apparatus is configured to independently include at least one new word or phrase in at least one of the current exercises, wherein the at least one new word or phrase is related to the current word or phrase received from the user.

7. The apparatus of claim 6, wherein the apparatus is configured to add the at least one new word or phrase to a user database for the user of words and/or phrases contained in previous exercises for the user.

8. The apparatus of claim 1, wherein:
higher levels of proficiency in the foreign language are associated with syntaxes of greater complexity;
one or more of the current exercises comprise sentences in the foreign language containing the translation of the current word or phrase; and
the apparatus is configured to:
maintain, for the user, a user database of words and/or phrases contained in previous exercises;
generate one or more of the current exercises based on at least some of the words and/or phrases in the user database;
add the current word or phrase to the user database;
independently include at least one new word or phrase in at least one of the current exercises, wherein the at least one new word or phrase is related to the current word or phrase received from the user; and
add the at least one new word or phrase to the user database for the user.

9. An apparatus-implemented method for teaching a foreign language to a user proficient in a native language, the method comprises the apparatus:
tracking a current level of proficiency of the user in the foreign language, wherein the current level of proficiency increases with the proficiency of the user in the foreign language;
receiving from the user a current word or phrase in the native language; and
generating a number of current exercises for the user to perform based on (i) a translation of the current word or phrase in the foreign language and (ii) the current level of proficiency of the user in the foreign language.

10. The method of claim 9, wherein higher levels of proficiency in the foreign language are associated with syntaxes of greater complexity.

11. The method of claim 9, wherein one or more of the current exercises comprise sentences in the foreign language containing the translation of the current word or phrase.

12. The method of claim 9, wherein the apparatus:
maintains, for the user, a user database of words and/or phrases contained in previous exercises; and
generates one or more of the current exercises based on at least some of the words and/or phrases in the user database.

13. The method of claim 12, wherein the apparatus adds the current word or phrase to the user database.

14. The method of claim 9, wherein the apparatus independently includes at least one new word or phrase in at least one of the current exercises, wherein the at least one new word or phrase is related to the current word or phrase received from the user.

15. The method of claim 14, wherein the apparatus adds the at least one new word or phrase to a user database for the user of words and/or phrases contained in previous exercises for the user.

16. The method of claim 9, wherein:
higher levels of proficiency in the foreign language are associated with syntaxes of greater complexity;
one or more of the current exercises comprise sentences in the foreign language containing the translation of the current word or phrase; and
the apparatus:
maintains, for the user, a user database of words and/or phrases contained in previous exercises;
generates one or more of the current exercises based on at least some of the words and/or phrases in the user database;
adds the current word or phrase to the user database;
independently includes at least one new word or phrase in at least one of the current exercises, wherein the at least one new word or phrase is related to the current word or phrase received from the user; and
adds the at least one new word or phrase to the user database for the user.
